(19) United States
(12) Patent Application Publication
(10) Pub. No.: US 2023/0191759 A1
(43) Pub. Date: Jun. 22, 2023

(54) Laminate

(71) Applicant: Plantic Technologies Ltd., Altona, Victoria (AU)

(72) Inventors: Masahiko Ota, Kurashiki-shi, Okayama (JP); Nicholas John McCaffrey, Altona, Victoria (AU); Brendan Leigh Morris, Altona, Victoria (AU)

(73) Assignee: Plantic Technologies Ltd., Altona, Victoria (AU)

(21) Appl. No.: 17/924,873

(22) PCT Filed: May 14, 2021
(86) PCT No.: PCT/IB2021/054128

§ 371 Date: Nov. 11, 2022

(30) Foreign Application Priority Data
May 15, 2020 (JP) 2020-086217

(51) Int. Cl. B32B 27/10; B32B 27/30; B32B 29/00; B32B 37/15

(52) U.S. Cl. CPC B32B 27/10; B32B 27/306; B32B 29/00; B32B 37/15; B32B 2037/148

(57) ABSTRACT

A laminate comprising: a gas barrier layer (I) comprising a modified starch (A) having an average amylose content of 45% by mass or more and a water-soluble polymer (B); and a substrate (II) adjacent to the gas barrier layer (I), wherein the laminate exhibits a degree of biodegradation of 80% or more in a biodegradability test in accordance with ISO 14855-1.

### TECHNICAL FIELD

The present invention relates to a laminate to be used for a food packaging material or the like, a multilayer structure comprising the laminate, and a packaging material or a lid material comprising the multilayer structure.

### BACKGROUND ART

To impart a gas barrier property (especially, oxygen barrier property) to a packaging material is an important function for protecting various products to be packaged from degradation due to gas, for example, oxidation due to oxygen, and the gas barrier property has been imparted by aluminum foil, metal vapor deposition on a plastic substrate, or multilayering with a gas barrier resin typified by EVOH. For example, Patent Document 1 discloses a gas barrier laminate having a gas barrier layer formed of a water-soluble polymer and an inorganic layered compound on a paper substrate.

Meanwhile, film materials containing starch as a main component have been studied from the viewpoint of reducing the environmental load. For example, Patent Document 2 discloses a multilayer film in which a starch layer is laminated on a substrate with an adhesive layer interposed therebetween, and the adhesive can secure adhesive strength between the substrate and the starch layer.

### PRIOR ART DOCUMENTS

### Patent Documents

Patent Document 1: JP-A-2009-184138
Patent Document 2: JP-A-2015-508341

### SUMMARY OF THE INVENTION

### Problems to be Solved by the Invention

However, the study of the present inventors has revealed that although the laminate as in Patent Document 1 has a gas barrier property, the repulpability is not sufficient and the laminate is not easily reused. In the laminate as in Patent Document 2, an adhesive is used in order to secure good adhesive strength between the substrate and the starch layer, and the degree of the repulpability is low due to the influence of the adhesive. As described above, it has been found that it is difficult to increase the repulpability while maintaining the gas barrier property and the adhesive strength between layers.

Thus, an object of the present invention is to provide a laminate being superior in gas barrier property, adhesive strength, and repulpability, a multilayer structure comprising the laminate, and a packaging material or a lid material comprising the multilayer structure.

### Means for Solving Problems

The present inventors have extensively studied for solving the above-described problems, and resultantly found that the above-described problems can be solved by, in a laminate comprising: a gas barrier layer (I) comprising a modified starch (A) and a water-soluble polymer (B); and a substrate (II), adjusting an average amylose content of the modified starch (A) to 45% by mass or more, making the gas barrier layer (I) and the substrate (II) adjacent to each other, and adjusting a degree of biodegradation of the laminate to 80% or more, leading to completion of the present invention. That is, the present invention includes the following embodiments.

[1] A laminate comprising: a gas barrier layer (I) comprising a modified starch (A) having an average amylose content of 45% by mass or more and a water-soluble polymer (B); and a substrate (II) adjacent to the gas barrier layer (I), wherein the laminate exhibits a degree of biodegradation of 80% or more in a biodegradability test in accordance with ISO 14855-1.

[2] The laminate according to [1], wherein the water-soluble polymer (B) is polyvinyl alcohol and/or polyoxyalkylene.

[3] The laminate according to [1] or [2], wherein the content of the modified starch (A) is 40 to 98 parts by mass and the content of the water-soluble polymer (B) is 2 to 60 parts by mass based on 100 parts by mass in total of the modified starch (A) and the water-soluble polymer (B).

[4] The laminate according to any one of [1] to [3], wherein the gas barrier layer (I) has a thickness of 1 to 600 μm.

[5] The laminate according to any of [1] to [4], wherein the substrate (II) is paper.

[6] A multilayer structure having a heat seal layer or a moisture-proof layer on at least one surface of the laminate according to any one of [1] to [5].

[7] A packaging material or a lid material comprising the laminate according to any one of [1] to [5] or the multilayer structure according to [6].

### Effects of the Invention

The laminate of the present invention is superior in gas barrier property, adhesive strength, and repulpability. Therefore, it can be suitably used for packaging materials or lid materials for foods, etc.

### BRIEF DESCRIPTION OF THE DRAWINGS

FIG. 1 is a schematic view of a twin screw extruder used in Examples.

FIG. 2 is a schematic view of an apparatus for producing a laminate used in Examples.

### EMBODIMENTS OF THE INVENTION

[Laminate]

The laminate of the present invention comprises a gas barrier layer (I) and a substrate (II) adjacent to the gas barrier layer (I).

<Gas Barrier Layer (I)>

The gas barrier layer (I) in the laminate of the present invention is a layer having a gas barrier property, and comprises a modified starch (A) and a water-soluble polymer (B).

<Modified Starch (A)>

The modified starch (A) is preferably at least one selected from the group consisting of an etherified starch, an esterified starch, a cationized starch, and a crosslinked starch from the viewpoint of being easy to enhance the gas barrier property, the adhesive strength, the biodegradability, and the repulpability.

Examples of the starch include starches derived from cassava, corn, potato, sweet potato, sago, tapioca, sorghum, bean, bracken, lotus, Trapa japonica, wheat, rice, oat, arrowroot, and pea. Inter alia, starch derived from corn or cassava is preferable, and starch derived from high amylose corn is further preferable. Starch may be used singly, or two or more kinds of starch may be used in combination.

Examples of the etherified starch include alkyl etherified starches, such as methyl etherified starch; carboxyalkyl etherified starches, such as carboxymethyl etherified starch; and hydroxyalkyl etherified starches, such as etherified starch having a hydroxyalkyl group having 2 to 6 carbon atoms. Alternatively, allyl etherified starches and the like can also be used.

Examples of the esterified starch include esterified starches having a structural unit derived from carboxylic acid, such as esterified starch having a structural unit derived from acetic acid; esterified starches having a structural unit derived from a dicarboxylic anhydride, such as esterified starch having a structural unit derived from maleic anhydride, esterified starch having a structural unit derived from phthalic anhydride, and esterified starch having a structural unit derived from octenylsuccinic anhydride; and esterified starches having a structural unit derived from oxo acid, such as nitric acid esterified starch, phosphoric acid esterified starch, and urea-phosphoric acid esterified starch. Other examples thereof include xanthogenic acid esterified starch and acetoacetic acid esterified starch.

Examples of the cationized starch include a reaction product of starch and 2-diethylaminoethyl chloride and a reaction product of starch and 2,3-epoxypropyltrimethylammonium chloride.

Examples of the crosslinked starch include formaldehyde-crosslinked starch, epichlorohydrin-crosslinked starch, phosphoric acid-crosslinked starch, and acrolein-crosslinked starch.

From the viewpoint of being easy to enhance the gas barrier property, the adhesive strength, the biodegradability, and the repulpability, the modified starch (A) is preferably at least one selected from the group consisting of an etherified starch having a hydroxyalkyl group having 2 to 6 carbon atoms and an esterified starch having a structural unit derived from a dicarboxylic anhydride, and is more preferably at least one selected from the group consisting of hydroxyethyl etherified starch, hydroxypropyl etherified starch, hydroxybutyl etherified starch, an esterified starch having a structural unit derived from maleic anhydride, an esterified starch having a structural unit derived from phthalic anhydride, and an esterified starch having a structural unit derived from octenylsuccinic anhydride. The modified starch (A) may be used singly, or two or more species thereof may be used in combination. In the present description, the number of carbon atoms prefixed to “starch” indicates the number of carbon atoms of a group that has substituted for one hydroxyl group in the starch (a group formed by modifying one hydroxyl group in the starch). For example, an etherified starch having a hydroxyalkyl group having 2 to 5 carbon atoms indicates that the number of carbon atoms of the hydroxyalkyl group formed by modifying one hydroxyl group in the starch is 2 to 5.

The etherified starch having a hydroxyalkyl group having 2 to 6 carbon atoms may be an etherified starch obtained by a reaction between alkylene oxide such as ethylene oxide, propylene oxide, or butylene oxide, and starch. The average number of hydroxy groups to be used in modification is preferably 0.05 to 2 per one glucose unit in the starch.

The modified starch (A) contained in the gas barrier layer (I) has an average amylose content of 45% by mass or more. If the average amylose content of the modified starch (A) is less than 45% by mass, the gas barrier property tends to decrease.

In the laminate of the present invention, since the average amylose content of the modified starch (A) contained in the gas barrier layer (I) is 45% by mass or more, the gas barrier property can be improved. The average amylose content of the modified starch (A) is preferably 45% by mass or more, more preferably 50% by mass or more, even more preferably 55% by mass or more, and further preferably 60% by mass or more. When the average amylose content is equal to or more than the above lower limit, the gas barrier property is more easily improved. The average amylose content in the modified starch (A) is usually 90% by mass or less. In the present description, the amylose content can be measured by, for example, the colorimetric iodine method described in “Starch Vol. 50, No. 4, 158-163 (1998)”. When the modified starch contains only a single kind of modified starch, the average amylose content means the amylose content of the single modified starch. When two or more modified starches are used, the average amylose content is determined by weighted averaging the amylose contents of the two or more modified starches. For this reason, for example, when two or more modified starches are used and the average amylose content is adjusted to 45% by mass or more, a modified starch with an amylose content of less than 45% by mass may be contained.

In the modified starch (A), the water content in the modified starch (A) may be preferably 5 to 15% by mass.

As the modified starch (A), a commercially available modified starch may be used. Examples of a representative commercial product of the modified starch (A) include ECOFILM (trademark) and National 1658 (trademark), which are hydroxypropyl etherified starches manufactured by Ingredion Incorporated.

The content of the modified starch (A) is preferably 40 parts by mass or more, more preferably 50 parts by mass or more, even more preferably 60 parts by mas or more, further preferably 70 parts by mass, and particularly preferably 75 parts by mass or more, whereas it is preferably 98 parts by mass or less, and more preferably 95 parts by mass or less, per 100 parts by mass in total of the modified starch (A) and the water-soluble polymer (B). When the content of the modified starch (A) is equal to or more than the above lower limit, the biodegradability and the repulpability are easily enhanced, and when the content of the modified starch (A) is equal to or less than the above upper limit, the gas barrier property is easily enhanced.

<Water-Soluble Polymer (B)>

The water-soluble polymer (B) is a polymer having compatibility with the modified starch (A). The water-soluble polymer (B) is not particularly limited, but preferably has a melting point suitable for the processing temperature of the modified starch (A) and, from the viewpoint of easily enhancing the gas barrier property, the adhesive strength, the biodegradability, and the repulpability, is preferably polyvinyl alcohol and/or polyoxyalkylene, and more preferably polyvinyl alcohol.

The polyvinyl alcohol preferably has a degree of saponification of 80 to 99.8 mol %. When the degree of saponification of the polyvinyl alcohol is in the above range, the gas barrier property, the adhesive strength, the biodegradability, and the repulpability are easily enhanced. The degree of saponification is more preferably 85 mol % or more, even more preferably 88 mol % or more, and particularly preferably 90 mol % or more. The degree of saponification refers to the molar fraction of hydroxyl groups to the total of hydroxyl groups and ester groups in the polyvinyl alcohol. The degree of saponification can be measured in accordance with JIS K 6726 (testing methods for polyvinyl alcohol), and can be measured, for example, by the method described in Examples.

The polyvinyl alcohol is produced, for example, by hydrolysis of polyvinyl acetate obtainable by polymerization of vinyl acetate monomers.

Regarding polyvinyl alcohol, the viscosity of a 4% aqueous solution of the polyvinyl alcohol at 20° C. measured in accordance with JIS Z 8803 is preferably 1 to 50 mPa·s. When the viscosity of the polyvinyl alcohol is in the above range, the gas barrier property, the adhesive strength, the biodegradability, and the repulpability tend to be easily enhanced. The viscosity is more preferably 3 mPa·s or more and even more preferably 5 mPa·s or more, and is more preferably 45 mPa·s or less and even more preferably 40 mPa·s or less.

The polyvinyl alcohol (B) can further comprise another monomer unit other than a vinyl alcohol unit. Examples of the other monomer unit include monomer units derived from ethylenically unsaturated monomers. Examples of the ethylenically unsaturated monomers include α-olefins such as ethylene, propylene, n-butene, isobutylene, and 1-hexene; acrylic acid and salts thereof; unsaturated monomers having an acrylic acid ester group; methacrylic acid and salts thereof unsaturated monomers having a methacrylic acid ester group; acrylamide, N-methylacrylamide, N-ethylacrylamide, N,N-dimethylacrylamide, diacetoneacrylamide, acrylamidopropanesulfonic acid and salts thereof, acrylamidopropyldimethylamine and salts thereof (e.g., quaternary salts); methacrylamide, N-methylmethacrylamide, N-ethylmethacrylamide, methacrylamidopropanesulfonic acid and salts thereof, methacrylamidopropyldimethylamine and salts thereof (e.g., quaternary salts); vinyl ethers such as methyl vinyl ether, ethyl vinyl ether, n-propyl vinyl ether, i-propyl vinyl ether, n-butyl vinyl ether, i-butyl vinyl ether, t-butyl vinyl ether, dodecyl vinyl ether, stearyl vinyl ether, and 2,3-diacetoxy-1-vinyloxypropane; vinyl cyanides such as acrylonitrile and methacrylonitrile; halogenated vinyls such as vinyl chloride and vinyl fluoride; halogenated vinylidenes such as vinylidene chloride and vinylidene fluoride; allyl compounds such as allyl acetate, 2,3-diacetoxy-1-allyloxypropane, and allyl chloride; unsaturated dicarboxylic acids such as maleic acid, itaconic acid, and fumaric acid, and salts or esters thereof; vinylsilyl compounds such as vinyltrimethoxysilane; isopropenyl acetate; vinyl ester monomers such as vinyl formate, vinyl acetate, vinyl propionate, vinyl butyrate, vinyl isobutyrate, vinyl pivalate, vinyl versatate, vinyl caproate, vinyl calrylate, vinyl laurate, vinyl palmitate, vinyl stearate, vinyl oleate, and vinyl benzoate. The content of the other monomer unit is preferably 10 mol % or less, and more preferably 5 mol % or less, with respect to the total molar amount of the structural units constituting the polyvinyl alcohol.

The method for producing the polyvinyl alcohol is not particularly limited. Examples thereof include a method comprising polymerizing a vinyl acetate monomer optionally with another monomer, and saponifying the resulting polymer to convert into a vinyl alcohol unit. Examples of a polymerization manner used in polymerization include batch polymerization, semi-batch polymerization, continuous polymerization, and semi-continuous polymerization. Examples of the polymerization method include publicly-known methods such as a mass polymerization method, a solution polymerization method, a suspension polymerization method, and an emulsion polymerization method. As the saponification of the polymer, a publicly-known method can be applied. For example, the saponification may be performed in a state where the polymer is dissolved in an alcohol or a hydrous alcohol. The alcohol that can be used at that time is a lower alcohol such as methanol and ethanol. The polyvinyl alcohol may be used singly or two or more species thereof may be used in combination.

The polyoxyalkylene represents a polyalkylene oxide and a polyalkylene glycol and has a structural unit represented by the following Formula (1) (also referred to as a structural unit (1)). The polyoxyalkylene may have two or more different structural units (1).

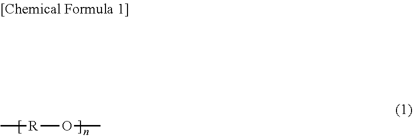

[In the formula, R is an alkylene group and n is 1 or more.]

In the Formula (1), examples of the alkylene group include alkylene groups having 2 to 10 carbon atoms such as an ethylene group, a propylene group, a trimethylene group, a butylene group, an isobutylene group, a pentylene group, a hexylene group, a heptylene group, an octylene group, a nonylene group and a decylene group. Among them, alkylene groups having 2 to 6 carbon atoms are preferable, and an ethylene group and/or a propylene group is more preferable from the viewpoint of easily enhancing the gas barrier property, the adhesive strength, the biodegradability, and the repulpability. When n is 2 or more, these alkylene groups may be used singly or two or more of them may be used in combination.

In in Formula (1) is preferably 5 or more, more preferably 50 or more, and even more preferably 100 or more, and is preferably 120,000 or less, and more preferably 70,000 or less from the viewpoint of easily enhancing the gas barrier property, the adhesive strength, the biodegradability, and the repulpability. When the polyoxyalkylene contains different structural units (1), the number of repetition n of each structural unit may be the same or different.

Examples of the polyalkylene oxide include polymers having a structural unit derived from an alkylene oxide having 2 to 6 carbon atoms, and specifically include polyethylene oxide, polypropylene oxide, polytrimethylene oxide (polyoxethane), polybutylene oxide, polyisobutylene oxide, and copolymers of monomers constituting the foregoing. Examples of the polyalkylene glycol include polymers having a structural unit derived from an alkylene glycol having 2 to 6 carbon atoms, and specifically include polyethylene glycol, polypropylene glycol, polytrimethylene glycol, polybutylene glycol, polyisobutylene glycol, and copolymers of monomers constituting the foregoing. Among them, the polyoxyalkylene is preferably polyethylene oxide, polypropylene oxide, polyethylene glycol, polypropylene glycol, or copolymers of monomers constituting them from the viewpoint of easily enhancing the gas barrier property, the adhesive strength, the biodegradability, and the repulpability. As the copolymer, a copolymer of ethylene oxide and propylene oxide, a copolymer of ethylene glycol and propylene glycol, and the like are preferable.

The polyoxyalkylene may contain a structural unit derived from a monomer other than the structural unit (1) as long as the effect of the present invention is not impaired. When the polyoxyalkylene is a copolymer, the polymerization mode of the copolymer is not particularly limited, and it may be in a random mode, a block mode, a graft mode, or a tapered mode. The polyoxyalkylene may be used singly or two or more species thereof may be used in combination.

The weight average molecular weight of the polyoxyalkylene is preferably 10,000 or more, more preferably 50,000 or more, and is preferably 5,000,000 or less, and more preferably 3,000,000 or less from the viewpoint of easily enhancing the gas barrier property, the adhesive strength, the biodegradability, and the repulpability.

As the polyoxyalkylene, a commercially available product may be used. Examples of representative commercial products of the polyoxyalkylene include ALKOX (trademark) E-75G, ALKOX (trademark) L-11, ALKOX (trademark) L-6, and ALKOX (trademark) EP1010N manufactured by Meisei Chemical Works, Ltd., PEO (trademark) PEO-1 and PEO-2 manufactured by Sumitomo Seika Chemicals Co., Ltd.

The content of the water-soluble polymer (B) is preferably 2 parts by mass or more and more preferably 5 parts by mass or more, is preferably 60 parts by mass or less, more preferably 50 parts by mass or less, even more preferably 40 parts by mass or less, further preferably 30 parts by mass or less, and particularly preferably 25 parts by mass or less, per 100 parts by mass in total of the modified starch (A) and the water-soluble polymer (B). When the content of the water-soluble polymer (B) is equal to or more than the above lower limit, the gas barrier property is easily enhanced, and when the content of the water-soluble polymer (B) is equal to or less than the above upper limit, the biodegradability and the repulpability are easily enhanced.

In the gas barrier layer (I), the total ratio of the modified starch (A) and the water-soluble polymer (B) is preferably 60% by mass or more, more preferably 80% by mass or more, even more preferably 85% by mass or more, and further preferably 90% by mass or more, and is preferably 100% by mass or less, with respect to the mass of the gas barrier layer (I). When the total ratio of the modified starch (A) and the water-soluble polymer (B) is in the above range, the gas barrier property, the adhesive strength, the biodegradability, and the repulpability are easily enhanced.

(Other Components) In the laminate of the present invention, the gas barrier layer (I) may further comprise a fatty acid having 12 to 22 carbon atoms and/or a fatty acid salt thereof. Examples of the fatty acid having 12 to 22 carbon atoms and a fatty acid salt thereof include stearic acid, calcium stearate, sodium stearate, palmitic acid, lauric acid, myristic acid, linoleic acid, and behenic acid. Among these, stearic acid, calcium stearate, and sodium stearate are preferable from the viewpoint of processability. The fatty acids having 12 to 22 carbon atoms and the fatty acid salts thereof may be used singly or two or more of them may be used in combination.

When the gas barrier layer (I) contains a fatty acid having 12 to 22 carbon atoms and/or a fatty acid salt thereof, the content thereof in the gas barrier layer (I) is preferably 0.01 to 3% by mass, more preferably 0.03 to 2% by mass, and even more preferably 0.1 to 1% by mass with respect to the mass of the gas barrier layer (I). When the content of the fatty acid having 12 to 22 carbon atoms and/or the fatty acid salt thereof is in the above range, it tends to be advantageous in terms of processability.

The gas barrier layer (I) may further comprise clay. Examples of the clay include synthetic or natural layered silicate clays such as montmorillonite, bentonite, beidellite, mica, hectorite, saponite, nontronite, sauconite, vermiculite, ledikite, magadite, kenyaite, stevensite, and volkonskoite. The clays may be used singly or two or more thereof may be used in combination.

When the gas barrier layer (I) contains clay, the content of the clay in the gas barrier layer (I) is preferably 0.1 to 5% by mass, more preferably 0.1 to 3% by mass, and even more preferably 0.5 to 2% by mass with respect to the mass of the gas barrier layer (I). When the clay content is in the above range, it tends to be advantageous in terms of transparency and strength.

When the later-described hydrous composition for forming the gas barrier layer (I) contains a plasticizer, film-forming property and coating property are improved when the gas barrier layer (I) is directly formed on the substrate (II), and the adhesive strength between the substrate (II) and the gas barrier layer (I) and the gas barrier property are easily enhanced. Therefore, the gas barrier layer (I) in the laminate preferably contains a plasticizer. Examples of the plasticizer include water, sorbitol, glycerol, maltitol, xylitol, mannitol, glycerol trioleate, epoxidized linseed oil, epoxidized soybean oil, tributyl citrate, acetyl triethyl citrate, glyceryl triacetate, 2,2,4-trimethyl-1,3-pentanediol diisobutyrate, polyethylene oxide, and polyethylene glycol. The plasticizers may be used singly or two or more thereof may be used in combination. Among these plasticizers, water is preferable from the viewpoint of easily enhancing the adhesive strength and the gas barrier property of the laminate.

The water content (the amount of water contained) in the gas barrier layer (I) is preferably 3% by mass or more, more preferably 4% by mass or more, and even more preferably 7% by mass or more, and is preferably 20% by mass or less, more preferably 18% by mass or less, and even more preferably 15% by mass or less with respect to the mass of the gas barrier layer (I). When the water content is in the above range, the gas barrier property and the adhesive strength are easily enhanced. The water content is a water content when a sample is pulverized to a maximum particle diameter of 1 mm or less with a Wonder Blender WB-1 and then measured at a temperature of 130° C. for 60 minutes using a heat-drying moisture meter.

The gas barrier layer (I) may further comprise additives such as fillers, processing stabilizers, weather resistance stabilizers, coloring agents, ultraviolet absorbing agents, light stabilizers, antioxidants, antistatic agents, flame-retardants, other thermoplastic resins, lubricants, perfumes, antifoaming agents, deodorants, bulking agents, releasing agents, mold releasing agents, reinforcing agents, crosslinking agents, fungicides, antiseptics, and crystallization rate retardants, as necessary.

The form of the gas barrier layer (I) is preferably a film or a sheet. The thickness of the gas barrier layer (I) is preferably 1 μm or more, more preferably 3 μm or more, even more preferably 5 μm or more, and particularly preferably 10 μm or more, and is preferably 600 μm or less, more preferably 500 μm or less, and even more preferably 450 μm or less from the viewpoint of easily enhancing the gas barrier property, the biodegradability, and the repulpability. One or two or more gas barrier layers (I) may be provided, and the gas barrier layer (I) may be a single layer or a multilayer. When there are two or more gas barrier layers (I), the thickness and the composition of each layer may be different or the same.

<Substrate (II)>

The laminate of the present invention includes a substrate (II) adjacent to the gas barrier layer (I). The substrate (II) is not particularly limited as long as the resulting laminate has a degree of biodegradation of 80% or more, and examples thereof include paper and biodegradable polyester.

(Paper Substrate)

The paper substrate may be, for example, a film or sheet comprising pulp, a filler, chemicals, and a pigment. Examples of the pulp include chemical pulps such as bleached hardwood kraft pulp (LBKP), bleached softwood kraft pulp (NBKP), unbleached hardwood kraft pulp (LUKP), unbleached softwood pulp (NUKP), and sulfite pulp; mechanical pulp such as stone ground pulp and thermomechanical pulp; wood fibers such as deinked pulp and waste paper pulp; and non-wood fibers obtained from kenaf, bamboo, hemp, etc. These pulps may be used singly or two or more thereof may be used in combination. Among them, chemical pulps, mechanical pulps, and wood fibers are preferable, and chemical pulps are more preferable from the viewpoint of easily suppressing the contamination of foreign substances in base paper and the occurrence of discoloration over time when a paper container after use is recycled and used, and easily improving surface feeling at the time of printing.

Examples of the filler include publicly-known fillers such as white carbon, talc, kaolin, clay, heavy calcium carbonate, light calcium carbonate, titanium oxide, zeolite, and synthetic resin fillers. The fillers may be used singly or two or more thereof may be used in combination. Examples of the chemicals include oxidized starch, hydroxyethyl etherized starch, enzyme-modified starch, polyacrylamide, polyvinyl alcohol, surface sizing agents (for example, neutral sizing agents), water-resistant agents, humectants, thickeners, lubricants, yield improvers, water-filterability improvers, and paper strengthening agents, and these may be used singly or two or more thereof may be used in combination. Examples of the yield improver include aluminum sulfate and various anionic, cationic, nonionic, or amphoteric yield improvers. Examples of dry paper strengthening agents include polyacrylamide and cationized starch, and examples of wet paper strengthening agents include polyamidoamine epichlorohydrin. These chemicals are added as far as there is no influence on formation, operability, etc. Examples of the neutral sizing agent include an alkyl ketene dimer, an alkenyl succinic anhydride, and a neutral rosin sizing agent. Examples of the pigment include inorganic pigments such as kaolin, clay, engineered kaolin, delaminated clay, heavy calcium carbonate, light calcium carbonate, mica, talc, titanium dioxide, barium sulfate, calcium sulfate, zinc oxide, silicic acid, silicate salts, colloidal silica, and satin white, and organic pigments such as a solid type, a hollow type, and a core-shell type, and these pigments may be used singly or two or more thereof may be used in combination. Furthermore, a dye, a fluorescent brightener, a pH adjusting agent, an antifoaming agent, a pitch control agent, a slime control agent, etc. may also be added as necessary. The surface of the paper substrate may be treated with various chemicals or pigments.

The method for producing a paper substrate (papermaking) is not particularly limited, and a paper substrate may be produced according to the acidic papermaking method, the neutral papermaking method, or the alkaline papermaking method using any publicly-known Fourdrinier former, on-top hybrid former, gap former machine, etc.

The method of treating the surface of the paper substrate is not particularly limited, but for example, any publicly-known coating machine such as a rod-metering size press, a pond size press, a gate-roll coater, a spray coater, a blade coater, a curtain coater, etc. may be used.

Examples of the paper substrate thus obtained include various publicly-known materials such as woodfree paper, wood containing paper, coated paper, single gloss paper, kraft paper, single gloss kraft paper, bleached kraft paper, unbleached kraft paper, rayon paper, tissue paper, glassine paper, paperboard, white paperboard, cellophane, and liner.

The paper substrate may have a transparent coating layer as part of the paper substrate on one side or both sides of the base paper described above. By applying transparent coating on the base paper, the surface strength and the smoothness of the base paper are easily improved, and the coatability when a pigment is applied is easily improved. The transparent coating layer may contain a polymer compound derived from starch as a binder. The amount of the transparent coating is preferably 0.1 to 4.0 g/m², and more preferably 0.5 to 2.5 g/m² in terms of solid content per one side. For example, using a coater (coating machine) such as a size press, a gate roll coater, a pre-metering size press, a curtain coater, or a spray coater, a coating liquid containing a starch such as starch or oxidized starch and a water-soluble polymer such as polyacrylamide or polyvinyl alcohol as main components may be applied to the base paper. It is also preferable to perform pre-calendering treatment on the base paper before coating with an online soft calender, an online chilled calender, or the like, thereby smoothing the base paper beforehand in order to uniformize the coated layer after the coating.

The paper substrate may be smoothed as necessary. For the smoothing treatment, a smoothing treatment apparatus such as a normal super calender, a gloss calender, a soft calender, a heat calender, or a shoe calender may be used. The smoothing treatment apparatus is appropriately used in on-machine or off-machine, and the form of the pressurizing device, the number of pressurizing nips, the heating temperature, etc. are appropriately adjusted.

(Biodegradable Polyester Substrate)

The biodegradable polyester substrate is not particularly limited as long as it is formed of a biodegradable polyester, and examples thereof include polyhydroxybutyrate, polyhydroxyhexanoate, polylactic acid (PLA), polycaprolactone, polybutylene succinate, polyadipate, polybutylene adipate, polytetramethylene adipate, polyethylene succinate, polyglycolic acid, poly(butylene adipate terephthalate) (PBAT), and poly(butylene succinate adipate) (PBSA).

The substrate (II) is preferably paper (paper substrate) from the viewpoint of more easily improving the biodegradability, the repulpability, and the adhesive strength of the laminate.

The basis weight of the substrate (II) is preferably 1 g/m² or more and more preferably 10 g/m² or more, and is preferably 500 g/m² or less, more preferably 400 g/m² or less, and even more preferably 300 g/m² or less. When the basis weight of the substrate (II) is in the above range, the gas barrier property, the adhesive strength, the biodegradability, and the repulpability are easily enhanced.

As to the substrate (II), either a single layer or two or more layers may be provided, and it may include either a single layer or multiple layers. When the substrate (II) includes two or more layers, the thickness and material of each layer may be either different or the same.

<Laminate>

The laminate of the present invention comprises a gas barrier layer (I) comprising a modified starch (A) having an average amylose content of 45% by mass or more and a water-soluble polymer (B) and a substrate (II) adjacent to the gas barrier layer (I), wherein the laminate exhibits a degree of biodegradation of 80% or more in a biodegradability test in accordance with ISO 14855-1. Thus, the laminate of the present invention is superior in biodegradability, gas barrier property, adhesive strength, and repulpability. Therefore, it can be suitably used for packaging materials or lid materials for foods, etc. Here, “adjacent” means that the gas barrier layer (I) and the substrate (II) are in contact with each other, and more specifically means that the gas barrier layer (I) is directly laminated on the surface of the substrate (II) with no other layer interposed therebetween.

In the present invention, a specific gas barrier layer (I) is used, and no adhesive is provided between a substrate (II) and the gas barrier layer (I), so that the degree of biodegradation is high, and superior repulpability can be achieved. In addition, even if no adhesive is used, sufficient adhesive strength between layers can be exhibited.

In the present specification, the repulpability refers to a characteristic capable of being disintegrated, more specifically, a characteristic of being easily disintegrated into fibers in a disintegrant, and can be evaluated, for example, by the method described in the section of [(3) Measurement of repulpability of laminate] in Examples. The adhesive strength indicates the strength of adhesion between the gas barrier layer (I) and the substrate (II).

The laminate of the present invention has a degree of biodegradation of 80% or more in a biodegradability test in accordance with ISO 14855-1. When the degree of biodegradation is less than 80%, not only biodegradability deteriorates, but also repulpability tends to deteriorate. In the present invention, since the degree of biodegradation is 80% or more, superior repulpability can be exhibited. The degree of biodegradation is preferably 85% or more, more preferably 90% or more, even more preferably 95% or more, and particularly preferably 97% or more. When the degree of biodegradation is equal to or more than the above lower limit, the repulpability is more easily enhanced. The upper limit of the degree of biodegradation is 100% or less. The degree of biodegradation can be measured by a biodegradability test in accordance with ISO 14855-1, and in the biodegradability test, the degree of biodegradation can be determined preferably on a base of after 168 days. The degree of biodegradation can be measured by the method described in Examples. The degree of biodegradation can be adjusted by, for example, using a component having high biodegradability as the substrate (II) or appropriately changing the amounts of the modified starch (I) and the water-soluble polymer (II) in the gas barrier property (I).

The laminate of the present invention is superior in gas barrier property, especially oxygen barrier property. The oxygen permeability (cc/[m²·atm·24 hr]) of the laminate of the present invention at 23° C. and 50% RH is preferably 10 or less, more preferably 8.0 or less, even more preferably 5.0 or less, further preferably 3.0 or less, and particularly preferably 1.0 or less. When the oxygen permeability is equal to or less than the above upper limit, a superior oxygen barrier property is easily exhibited. The oxygen permeability (cc/[m²·atm·24 hr]) is usually 0.01 or more. The oxygen permeability of a resin composition can be measured with an oxygen permeation analyzer after storing the resin composition at 23° C. and 50% RH for two weeks to adjust the humidity, and can be measured, for example, by the method described in Examples. In the present description, the expression that the oxygen barrier property is improved or enhanced means that the oxygen permeability is reduced, and the expression that an item is superior in oxygen barrier property means that the item is low in oxygen permeability.

The laminate of the present invention is superior in adhesive strength between the substrate (II) and the gas barrier layer (I) even without using an adhesive. The adhesive strength is preferably 1 N/15 mm or more, more preferably 2 N/15 mm, even more preferably 3 N/15 mm or more, further preferably 4 N/15 mm or more, and particularly preferably 5 N/15 mm or more. The upper limit of the adhesive strength is usually 100 N/15 mm or less, and preferably 50 N/15 mm or less. The adhesive strength can be measured using a tensile tester at a peeling angle of 180° and a speed of 100 mm/min after the laminate is conditioned at 23° C. and 50% RH for two weeks, and can be measured, for example, by the method described in Examples. The adhesive strength may be adjusted to the above range by, for example, appropriately adjusting the kind of the substrate (I) and the kind and ratio of the components in the gas barrier layer (I), especially using the above-mentioned preferable components or adjusting their ratio to the above-mentioned preferable range; adjusting the water content of the gas barrier layer (I) in the laminate to the above range, that is, producing a laminate using a hydrous composition having a prescribed water content; or employing the method for producing a laminate described later.

The water content (the amount of water contained) in the laminate of the present invention is preferably 3% by mass or more, more preferably 4% by mass or more, and even more preferably 7% by mass or more, and is preferably 20% by mass or less, more preferably 18% by mass or less, and even more preferably 15% by mass or less, with respect to the mass of the laminate. When the water content of the laminate is in the above range, the gas barrier property and the adhesive strength are easily enhanced. The water content is a water content when a sample is pulverized to a maximum particle diameter of 1 mm or less with, for example, a Wonder Blender WB-1 (Osaka Chemical Co., Ltd.) and then measured at a temperature of 130° C. for 60 minutes using a heat-drying moisture meter, and can be measured by the method described in Examples.

Examples of the layer configuration of the laminate are not particularly limited and include gas barrier layer (I)/substrate (II); substrate (II)/gas barrier layer (I)/substrate (II); and gas barrier layer (I)/substrate (II)/gas barrier layer (I).

[Method for Producing Laminate]

The method for producing the laminate of the present invention is not particularly limited, but for example, a method comprising a step of coating a substrate (II) with a hydrous composition comprising the modified starch (A) and the water-soluble polymer (B) (sometimes referred to as Step (X)) is preferable. When such a method is used, since the gas barrier layer (I) can be laminated on the substrate (II) without using an adhesive, biodegradability and repulpability can be improved and sufficient adhesive strength can be obtained.

<Production of Hydrous Composition>

The hydrous composition comprises a resin composition comprising the modified starch (A) and the water-soluble polymer (B) and has a water content of 1 to 50% by mass. The water content is preferably 5% by mass or more, and more preferably 8% by mass or more, and is preferably 45% by mass or less, and more preferably 40% by mass or less. When the water content is in the above range, it is easy to improve the coating property and the film-forming property when coating the substrate (II) with the hydrous composition, and it is easy to enhance the adhesive strength between the substrate (II) and the gas barrier layer (I) in the resulting laminate. Furthermore, the gas barrier property is easily improved. The water content of the hydrous composition is, for example, a water content measured at a temperature of 130° C. for 60 minutes using a heat-drying moisture meter, and can be measured by the method described in Examples. In the present description, it is meant that the hydrous composition includes all of the resin compositions containing water having a water content of 1 to 50% by mass measured by the above method. That is, the hydrous composition is preferably one having a water content adjusted to the above range by adding water to a resin composition, and also includes a resin composition having a water content in the above range at the time of production.

The resin composition can be produced by, for example, a method comprising at least Step (1) of mixing the modified starch (A) and the water-soluble polymer (B) to obtain a mixture, Step (2) of extruding the mixture, and Step (3) of cooling and drying the extruded mixture. The components contained in the resin composition are the same as the components contained in the gas barrier layer (I), and the water contents thereof may be the same as or different from each other, and can be preferably chosen from the same range as the water content of the gas barrier layer (I).

Step (1) is a step of mixing at least the modified starch (A) and the water-soluble polymer (B), and optionally other components, for example, the fatty acid having 12 to 22 carbon atoms and/or a fatty acid salt thereof, the clay, the plasticizer, the additive, etc. may be mixed together.

Step (1) is usually performed using an extruder. In the extruder, a shearing stress is applied to each component with a screw, and each component is uniformly mixed while heating by application of the external heat to a barrel.

As the extruder, for example, a twin screw extruder can be used. The twin screw extruder may be co-rotation or reverse rotation. The screw diameter may be, for example, 20 to 150 mm, and the L/D ratio of the extruder length (L) to the screw diameter (D) may be, for example, 20 to 50. The rotation speed of the screw is preferably 80 rpm or more, and more preferably 100 rpm or more. The extrusion pressure is preferably 5 bar (0.5 MPa) or more, and more preferably 10 bar (1.0 MPa) or more. Each component can be introduced directly into the extruder. Further, each of the components may be premixed using a mixer and then introduced into the extruder.

In Step (1), from the viewpoint of easily enhancing the film-forming property and the gas barrier property, it is preferable to mix a plasticizer, preferably water, in an amount whose lower limit is preferably 0.1% by mass or more, more preferably 1% by mass or more, even more preferably 10% by mass or more, particularly preferably 15% by mass or more, and most preferably 20% by mass or more and whose upper limit is preferably 50% by mass or less, more preferably 45% by mass or less, and even more preferably 40% by mass or less with respect to the mass of the mixture. Here, the mass of the mixture is the total mass of the mixture including the plasticizer. In Step (1), the plasticizer may be introduced into the extruder at an initial stage of extrusion, and the plasticizer can be introduced before the temperature reaches the aforementioned heating temperature, for example, at 100° C. or lower. The modified starch (A) is subjected to the cooking treatment by the combination of the moisture, the heat, and the shearing stress, and can be gelatinized (gelled). Further, by separately introducing the plasticizer, preferably water, the water-soluble polymer (B) is dissolved, the resin composition is softened, and the modulus and the brittleness can be reduced.

In Step (1), cooking treatment is performed by heating to a temperature of preferably higher than 100° C. and 150° C. or lower, and more preferably 115° C. or higher and 140° C. or lower. Here, the cooking treatment is treatment of grinding and gelling starch particles. The heating can be performed by applying heat to the barrel of the extruder from the outside. Each barrel can be heated to a target temperature by applying temperature that is changed stepwise. When the cooking treatment is performed at a temperature higher than 120° C., this is advantageous in terms of processability.

In order to prevent foaming, it is preferable to push the cooked mixture toward a die while cooling it to a temperature of preferably 85 to 120° C., more preferably 90 to 110° C. Further, by exhausting the air from the barrel, foaming can be prevented and the moisture can be removed.

The residence time in the extruder can be set according to the temperature profile and the screw speed, and is preferably 1 to 2.5 minutes.

In Step (2) of extruding the mixture, the molten mixture that has been pushed in the extruder while being melt-kneaded is extruded through the die. The temperature of the die is preferably 85 to 120° C., and more preferably is 90 to 110° C.

In Step (3) of cooling and drying the extruded mixture (melt), the mixture (melt) may be extruded into a film shape, a sheet shape, or a strand shape.

When the mixture is extruded into a film shape, the mixture can be extruded through a die for forming a film, and then cooled and dried while being wound with a winding roller. It is preferable to cool the mixture between the die and the roller so as to prevent the mixture from adhering to the roller. A shaping roll may be installed between the die and the roller. The material of the shaping roll is, for example, rubber, resin, or metal. For drying, the roll may be warmed or dehumidified air may be supplied during winding. In the case of the blowing-tube method, the dehumidified air can be used in order to inflate the film when the film is released from the die. By accompanying talc in the air stream, blocking of the film can be prevented.

When the mixture is extruded into a strand shape, the mixture is extruded through a multi-hole strand nozzle, and strands are cut with a rotary cutter, so that the strands can be formed into a pellet shape. In order to prevent the pellets from agglutinating, the moisture in the pellets may be removed by applying vibration periodically or regularly and using hot air, dehumidified air or an infrared heater.

In a preferred embodiment of the present invention, after the formation of the resin composition, water is added to form a hydrous composition, and therefore the form of the resin composition is preferably a pellet form.

In a preferred embodiment of the present invention, a hydrous composition can be obtained by adding water to the resulting resin composition (preferably a resin composition in a pellet form) and stirring and mixing, for example. In order to prevent the resin compositions from agglutinating to each other and to adsorb water to the entire pellet, it is preferable to perform stirring while adding water in two or more portions. Further, in order to keep the water content constant, the hydrous composition may be stored in a closed container.

<Production of Laminate>

Step (X) is preferably a step of coating the substrate (II) conveyed by the winding machine with the hydrous composition using an extruder.

In Step (A), the hydrous composition is preferably introduced into an extruder. Examples of the extruder include a single screw extruder and a twin screw extruder. The screw diameter of the extruder is, for example, 20 to 150 mm, the L/D ratio of the extruder length (L) to the screw diameter (D) is, for example, 15 to 50, and the rotation speed of the screw is preferably 80 rpm or more, and more preferably 100 rpm or more. The cylinder temperature in the extruder may be, for example, 80 to 120° C., and preferably 90 to 110° C.

The hydrous composition charged into the extruder is plasticized and discharged through a die outlet. A substrate (II) is conveyed by a winding machine, preferably a roller type winding machine. By coating the conveyed substrate (II) with the hydrous composition discharged through the die outlet, a laminate is obtained. The resulting laminate is conveyed while being pressure-bonded to the substrate (II) between a plurality of rolls including a metal roll, and can be wound into a roll form by a winding machine. Examples of the plurality of rolls include pressure rolls, cast rolls, and touch rolls. In this way, a laminate comprising the gas barrier layer (I) and the substrate (II) adjacent to the gas barrier layer (I) can be obtained.

In Step (X), the draw ratio represented by the following formula is preferably 5 to 20.

Draw ratio=(Winding speed of the winding machine)/(Flow rate at the die outlet of the extruder)

When a laminate is produced with such a draw ratio, the productivity is improved and a laminate superior in adhesive strength between a substrate (II) and a gas barrier layer (I) as well as in gas barrier property tends to be obtained. The flow rate at the die outlet of the extruder is represented by (discharge amount)/((lip opening)×(die width)). When the discharge amount is expressed by the mass per unit time, the discharge amount is preferably 1 to 500 kg/hr, and more preferably 5 to 200 kg/hr, the lip opening is preferably 0.01 to 5 mm, and more preferably 0.1 to 1 mm, and the die width is preferably 100 to 3000 mm, and more preferably 200 to 2000 mm. In the present invention, since the water of the hydrous composition evaporates during the above-described production process, the water content of the gas barrier layer (I) in the resulting laminate is made lower than that of the hydrous composition. The laminate obtained may be dried to adjust the water content.

In another embodiment of the present invention, examples of the method for producing the laminate of the present invention include a method comprising a step of coating the gas barrier layer (I) with a material for forming the substrate (II) (sometimes referred to as Step (Y)). In this embodiment, the gas barrier layer (I) can be formed from the hydrous composition using the extruder, and can be formed into, for example, a sheet or a film. The material for forming the substrate (II) is not particularly limited, and examples thereof include the biodegradable polyester described above.

Step (Y) is preferably a step of coating the gas barrier layer (I) conveyed by the winding machine with the material described above using an extruder.

In Step (Y), the material is preferably introduced into the extruder. Examples of the extruder include a single screw extruder and a twin screw extruder. The screw diameter, the L/D ratio, and the screw rotation speed of the extruder may be similar to the ranges described for Step (X). The cylinder temperature in the extruder may be appropriately chosen according to the type of the material and may be, for example, 100 to 270° C., and preferably 150 to 250° C.

The material introduced into the extruder is discharged through a die outlet. On the other hand, a gas barrier layer (I) is conveyed by a winding machine, preferably a roller type winding machine. By coating the conveyed gas barrier layer (I) with the material discharged through the die outlet, a laminate is obtained. The resulting laminate is conveyed while being pressure-bonded to the gas barrier layer (I) between a plurality of rolls including a metal roll, and can be wound into a roll form by a winding machine.

In the method for producing the laminate of the present invention, the method including Step (X) can be suitably used when the substrate is a paper substrate, and the method including Step (Y) can be suitably used when the substrate is a biodegradable polyester substrate.

[Multilayer Structure]

The laminate of the present invention can form a multilayer structure by laminating another layer on at least one surface of the laminate. Examples of the other layer include a resin layer.

As the resin that forms the resin layer comprised in the multilayer structure of the present invention, for example, fossil resource-derived resins such as polyester, polyvinyl alcohol, polypropylene, polyethylene, polystyrene, polyethylene terephthalate, polybutylene terephthalate, polymethylpentene, polyvinyl chloride, acrylonitrile-butadiene-styrene, acrylonitrile-styrene, polymethylmethacryl, polyvinylidene chloride (PVDC), polyamide (nylon), polyacetal, and polycarbonate; and bio-derived resins such as polylactic acid (PLA), esterified starch, cellulose acetate, polybutylene succinate (PBS), polybutylene succinate adipate (PBSA), bio-polyethylene, bio-polyethylene terephthalate, and bio-polyurethane are preferable. Incidentally, the bio-derived resin means a polymer material having a number average molecular weight (Mn) of 1,000 or more which contains a substance derived from a renewable organic resource as a raw material and is preferably obtained by chemical or biological synthesis.

As the fossil resource-derived resin and the bio-derived resin, any of biodegradable resins such as polylactic acid (PLA), esterified starch, cellulose acetate, polybutylene succinate (PBS), and polybutylene succinate adipate (PBSA), and non-biodegradable resins such as polyethylene, polypropylene, polyester, polyethylene terephthalate, polyamide (nylon), and bio-polyethylene may be used. When a biodegradable resin is used as the resin constituting the resin layer, higher biodegradability and higher repulpability are easily exhibited even in a multilayer structure.

The biodegradable resin means a resin having a property of being decomposed to a molecular level by the action of microorganisms, and eventually decomposed to carbon dioxide and water and returned to nature.

In the present invention, examples of the method for laminating the resin layer include an extrusion coating method, an extrusion lamination method, and a method of bonding film such as barrier film and vapor-deposited film.

In the case of the extrusion coating method, the above-mentioned various resins are extrusion-coated or laminated with an adhesive resin and a primer layer interposed on at least one surface of the gas barrier layer (I)/the substrate (II). In the case of the method of bonding film, a film of the above-mentioned various resins is bonded as a resin laminate layer on the surface of at least one of the gas barrier layer (I)/the substrate (II) by a dry lamination method, a sand lamination method, or the like.

In the method of bonding film, as the film to be used for the bonding layer, in addition to the above-mentioned films made of various resins, barrier films such as films obtained by bonding metal foils made of various metals such as aluminum to the above-mentioned films made of various resins, and vapor-deposited films obtained by vapor-depositing various metals such as aluminum or inorganic oxides such as silicon oxide and aluminum oxide on the above-mentioned films made of various resins can be used.

Examples of the adhesive to be used in the case of the method of bonding film include acrylic adhesives, urethane-based adhesives, epoxy-based adhesives, vinyl acetate-based adhesives, ethylene-vinyl acetate-based adhesives, vinyl chloride-based adhesives, silicone-based adhesives, nitrile cellulose-based adhesives, phenol-based adhesives, polyvinyl alcohol-based adhesives, melamine-based adhesives, and styrene-based adhesives. From the viewpoint of adhesiveness, urethane-based adhesives are preferable. The thickness of the adhesive layer is preferably 0.1 to 30 μm, and more preferably 1 to 20 μm. The thickness of the adhesive layer can be measured using an optical microscope, a film thickness meter, or the like.

Also in the multilayer structure of the present invention, it is preferable not to use the adhesive when higher biodegradability and higher repulpability are exhibited. In such a case, the resin layer is preferably laminated directly (adjacently) on the surface of at least one of the gas barrier layer (I) and the substrate (II) by extrusion coating, extrusion lamination, or the like. The multilayer structure of the present invention may have one or two or more resin layers, and when having two or more resin layers, the types of the resin layers may be the same or different.

The resin layer comprised in the multilayer structure of the present invention may be, for example, a biodegradable resin layer, a heat seal layer, a moisture-proof layer, an inorganic vapor-deposited layer, or a light-shielding layer, and is more preferably a heat seal layer or a moisture-proof layer. That is, in a preferred embodiment of the present invention, the multilayer structure of the present invention has a heat seal layer or a moisture-proof layer on at least one surface of the laminate of the present invention. The heat seal layer is a layer formed of the resin and capable of heat bonding (heat sealing). The moisture-proof layer is a layer formed of the resin and having a moisture-proof effect.

Examples of the layer configuration of the multilayer structure of the present invention will be described below. In the multilayer structure having the following layer configurations, the gas barrier layer (I) and the substrate (II) are adjacent to each other, but an adhesive layer or another layer may be comprised at a position other than between these layers. In the following layer configurations, it is preferable that layers other than the gas barrier layer (I) and the substrate (II) function as a heat seal layer or a moisture-proof layer.

Where the gas barrier layer (I) is denoted by (I), the substrate (II) is denoted by (II), and a polyester layer is denoted by (L1), the following configurations can be mentioned.

(I)/(II)/(L1); (L1)/(I)/(II); (L1)/(I)/(II)/(L1);

further, the following configurations can be mentioned where a polyolefin layer is denoted by (L2).

(I)/(II)/(L2); (L2)/(I)/(II); (L2)/(I)/(II)/(L2); (L1)/(I)/(II)/(L2); (L2)/(I)/(II)/(L1);

further, the following configurations can be mentioned where a biodegradable resin layer is denoted by (L3).

(L3)/(I)/(II); (I)/(II)/(L3); (L3)/(I)/(II)/(L3); (L1)/(I)/(II)/(L3); (L2)/(I)/(II)/(L3); (L3)/(I)/(II)/(L1); (L3)/(I)/(II)/(L2);

further, following configurations can be mentioned where an inorganic vapor-deposited layer is denoted by (L4).

(I)/(II)/(L4)/(L2);(I)/(II)/(L4)/(L1);(I)/(II)/(L4)/(L3);(L2)/(I)/(II)/(L4)/(L2) (L1)/(I)/(II)/(L4)/(L2);(L3)/(I)/(II)/(L4)/(L2);(L1)/(I)/(II)/(L4)/(L1);(L3)/(I)/(II)/(L4)/(L1);(L3)/(I)/(II)/(L4)/(L3);(L2)/(L4)/(I)/(II);(L1)/(L4)/(I)/(II);(L3)/(L4)/(I)/(II); (L2)/(L4)/(I)/(II)/(L2);(L1)/(L4)/(I)/(II)/(L2);(L3)/(L4)/(I)/(II)/(L2);(L1)/(L4)/(I)/(II)/(L1);(L3)/(L4)/(I)/(II)/(L1);(L3)/(L4)/(I)/(II)/(L3)

Since the multilayer structure of the present invention comprises the laminate of the present invention, the multilayer structure is superior in gas barrier property and adhesive strength. Furthermore, the multilayer structure in a preferred embodiment of the present invention is also superior in biodegradability and repulpability.

The laminate or multilayer structure of the present invention can be used for, for example, packaging materials for food and the like, barrier packaging materials to be used for packaging applications such as containers and cups, industrial materials, etc. Among them, it can be suitably used as packaging materials for foods and the like and barrier packaging materials to be used for containers, cups and the like, and particularly suitably used as soft packaging materials for foods and the like. The soft packaging material is a packaging material constituted of a highly flexible material, and generally refers to a packaging material in which a thin and flexible material such as paper, film, or aluminum foil is used alone or these are bonded together. Shape-wise, a soft packaging material is a bag or other packaging material that maintains a three-dimensional shape while contents are put inside.

When the laminate or multilayer structure of the present invention is used as a packaging material for food or the like, especially as a soft packaging material, by laminating or containing a heat-sealable resin layer (the heat seal layer), the sealability as a packaging material is enhanced, so that the contents are protected from degradation due to oxidation or the like caused by oxygen and the storage period can be easily extended.

When it is used as a laminate or multilayer structure to be used for industrial materials, etc., the laminate or multilayer structure of the present invention can reduce intrusion of oxygen to prevent decay and degradation, and it is also expected to demonstrate a flavor barrier property that prevents the smell of a solvent from leaking out.

[Packaging Material or Lid Material]

The present invention includes a packaging material or a lid material comprising the laminate or the multilayer structure of the present invention. The packaging material is not particularly limited, and examples thereof include the barrier packaging material described above. The lid material is not particularly limited, and examples thereof include a lid material for containers. When the lid material is used as a lid material for containers, it can seal the inside of a container by being combined with a container body.

Since the packaging material or the lid material of the present invention includes the laminate, the packaging material or the lid material is superior in gas barrier property, interlayer adhesive strength, and repulpability, and therefore can be suitably used for food applications, and can reduce an environmental load.

### EXAMPLES

The present invention is described in detail by way of Examples, but the present invention is not limited to them.

<Test Methods>

(1) Measurement of Oxygen Permeability

The laminates obtained in Examples and Comparative Examples were each stored at 23° C. and 50% RH for two weeks to adjust the humidity, and then mounted to an oxygen permeation analyzer, and the oxygen permeability was measured. The measurement conditions are as follows.

Instrument: “MOCON OX-TRAN2/20” manufactured by Modern Controls, Inc.

Temperature: 23° C.

Humidity on oxygen supply side and carrier gas side: 50% RH

Oxygen pressure: 1.0 atm

Carrier gas pressure: 1.0 atm

(2) Measurement of Biodegradability of Laminate

The laminate obtained in each of Examples and Comparative Examples was cut into 1×1 cm, and the degree of biodegradation was derived from the amount of carbon dioxide generated in biodegradation after a lapse of 168 days under aerobic conditions based on ISO 14855-1.

Degree of biodegradation (%)=((CO₂)T−(CO₂)B)/(MToT×CToT×44/12)×100

(CO₂)T: Integrated amount (g) of CO₂ discharged from the compost container

(CO₂)B: Integrated amount (g) of CO₂ discharged from a blank test container

MToT: Dry solid amount (g) of the test material put in a compost container

CToT: Relative amount (g/g) of total organic carbon (TOC) in the dry solid of the test material

(3) Measurement of Repulpability of Laminate

In accordance with JAPAN Tappi No. 39, a laminate was disintegrated using a standard disintegrator (manufactured by KUMAGAI RIKI KOGYO Co., Ltd.) at a concentration of paper of 4.5% and a temperature of 50 to 60° C. by adding, as chemicals, 1.0% (vs. paper) of sodium hydroxide, 2.0% (vs. paper) of No. 3 silicic acid, and 1.0% (vs. paper) of hydrogen peroxide. Unbleached kraft paper (Taio Atras, basis weight: 50 g/m²) was used as a comparison sample, and was visually evaluated according to the following criteria.

A=The laminate was disintegrated within 5 minutes as compared with the comparative sample, and the undisintegrated pieces disappeared.

B=The laminate was disintegrated in 5 minutes or more as compared with the comparative sample, and the undisintegrated pieces disappeared within 1 hour from the completion time of A.

C=The undisintegrated pieces remained even after 1 hour from the completion time of A.

(4) Measurement of Adhesive Strength of Laminate

The laminate obtained in each of Examples and Comparative Examples was conditioned at 23° C. and 50% RH for two weeks, and then cut into a strip shape having a length of 150 mm and a width of 15 mm. Subsequently, the gas barrier layer (I) and the substrate (II) were peeled from each other, and the gas barrier layer (I) and the substrate (II) were pulled at a rate of 100 mm/min at an angle of 180° with the tensile tester shown below to measure adhesive strength (N/15 mm). The arithmetic mean calculated from the measurements of five specimens of each sample was taken as adhesive strength.

Tensile tester: “INSTRON3367” manufactured by Instron Corporation, load cell: 500 N

(5) Measurement of Degree of Saponification of Polyvinyl Alcohol (B)

In accordance with JIS K 6726 (Testing Methods for Polyvinyl Alcohol), dissolution titration of polyvinyl alcohol in Examples and Comparative Examples was performed and the degree of saponification was calculated.

(6) Measurement of Viscosity of Polyvinyl Alcohol (B)

In accordance with JIS Z 8803 (falling ball viscometer) and JIS K 6726 (testing methods for polyvinyl alcohol), a 4% aqueous solution of each of the polyvinyl alcohols in Examples and Comparative Examples was prepared and its viscosity at 20° C. was measured using a Hoppler viscometer and was taken as the viscosity (20° C.) in a 4% aqueous solution of the polyvinyl alcohol (B).

(7) Measurement of Water Content (Amount of Water Contained)

The water content of the hydrous compositions and the laminates obtained in Examples and Comparative Examples (the ratio of water to the total mass of a laminate) was confirmed by pulverizing the sample to a maximum particle diameter of 1 mm or less using a Wonder Blender WB-1 (Osaka Chemical Co., Ltd.), and then measuring the water content at 130° C. for 60 minutes using a heat-drying moisture meter “HR73” manufactured by Mettler-Toledo International Inc.

(8) Materials Used

<Modified Starch (A)>
(A-1): ECOFILM (registered trademark); corn starch modified with propylene oxide, amylose content=70% by mass, available from Ingredion Inc.
(A-2): National 1658 (registered trademark); corn starch modified with propylene oxide, amylose content=20% by mass, available from Ingredion Inc.

<Water-Soluble Polymer (B)>
(B-1): ELVANOL (registered trademark) 71-30; polyvinyl alcohol resin, degree of saponification=99.5 mol %, viscosity=30 mPa·s (20° C., 4% aqueous solution), manufactured by Kuraray Co., Ltd.
(B-2): ALKOX (registered trademark) L-11: polyethylene oxide resin, weight-average molecular weight=100,000, manufactured by Meisei Chemical Works, Ltd.

<Other Materials (C)>
(C-1): PVDC film; Saran (registered trademark) film 700, 43 μm thick, manufactured by Asahi Kasei Corp.
(C-2): EVOH film; EVAL (registered trademark) film EF-XL, 12 μm thick, manufactured by Kuraray Co., Ltd.
(C-3): aluminum foil; MyFoil for commercial use, 12 μm thick, manufactured by UACJ Foil Corporation

<Substrate (II)>
Unbleached kraft paper: Taio Atras, basis weight: 50 g/m², manufactured by Daio Paper Corporation
Bleached kraft paper: Snow Queen G40, basis weight: 50 g/m², manufactured by Daio Paper Corporation
Single gloss kraft paper: Star White, basis weight 40 g/m², manufactured by Marusumi Paper Co., Ltd.
Glassine paper: thick glassine, basis weight: 31 g/m², manufactured by Nippon Paper Industries Co., Ltd.
Tissue paper: tissue paper for food paper, basis weight: 21 g/m², manufactured by Shirakawa Paper Co., Ltd.
Rayon paper: Rayon Paper <208>, basis weight: 14 g/m², manufactured by Okura Paper Co., Ltd.
White paperboard: Hokuetsu Artpost, basis weight 233 g/m², manufactured by Hokuetsu Corporation
Woodfree paper: SHIRAOI, basis weight: 110 g/m², manufactured by Nippon Paper Industries Co., Ltd.
Coated paper: Ryuuo Coate, basis weight: 55 g/m², manufactured by Daio Paper Corporation
Cellophane: Plain Cellophane PL, basis weight: 20 g/m², manufactured by Futamura Chemical Co., Ltd.
PBAT/PLA blend: Ecovio F2341, basis weight: 50 g/m², manufactured by BASF SE

Hereinafter, the description of the product name and the manufacturer of the substrate (II) will be omitted.

### Example 1

(Resin Composition)

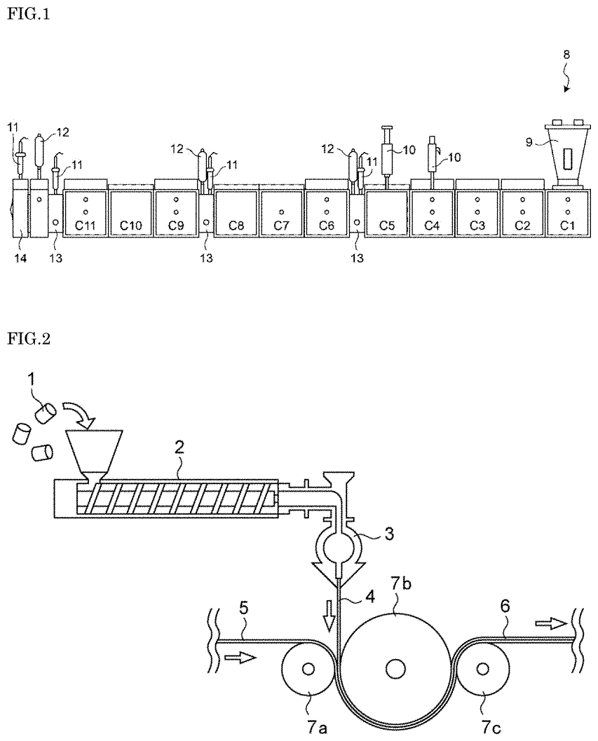

As raw materials, 90 parts by mass of modified starch (A-1) and 10 parts by mass of water-soluble polymer (B-1) were mixed in a tumbler mixer for 2 hours, and the resulting mixture was fed to a twin screw extruder to which a liquid pump was connected. FIG. 1 shows a schematic view of the twin screw extruder used in Example 1, and the screw diameter, the L/D ratio, the rotation speed, the operation mode, and the temperature profile (Table 1) of the extruder are shown below.

TABLE 1
Temperature profile [° C.]:

| C1 | C2 | C3 | C4 | C5 | C6 | C7 | C8 | C9 | C10 | C11 | Adapter | Die |
|---|---|---|---|---|---|---|---|---|---|---|---|---|
| 40 | 70 | 80 | 90 | 120 | 140 | 130 | 120 | 120 | 100 | 100 | 100 | 100 |

Screw diameter: 27 mm

L/D ratio: 48

Screw rotation speed: 500 rpm

Operation mode: co-rotation (engaging self-wiping) mode

Specifically, the resulting mixture was fed at a rate of 3.5 kg/hour into the barrel through the hopper at C1 via the weight feeder of the twin screw extruder. Water was injected at a flow rate of 26 g/min into the barrel through the liquid pump (L) at C4. The temperature ranges of C5 to C9 are cooking ranges, and complete gelatinization was completed within these ranges. The strand die is positioned after C11. The resin composition was extruded through a multi-hole strand nozzle and cut with a rotary cutter. Thus, strands were formed into a pellet shape. Since the pellets contained excess water, the water was removed by hot air while constantly applying vibration in order to prevent agglutinating.

(Hydrous Composition)

To the resulting pelletized resin composition was added water up to an amount of 35% by mass with respect to the mass of the resin composition. At the time of the addition of the water, in order to prevent the pellets from agglutinating to each other and to allow the pellets to absorb water uniformly, the mixture was stirred with a tumbler mixer for 15 minutes while adding the water in multiple portions. After the stirring, the mixture was sealed in a polyethylene bag such that water would not volatilize, and was allowed to stand at room temperature for 6 hours. In this way, a hydrous composition (hydrous pellets) having a water content of 35% by mass was obtained.

(Laminate)

The resulting hydrous composition (pellet form) 1 was charged into a single screw extruder 2 shown in FIG. 2 and extruded from a film forming die 3. Subsequently, the substrate 5 (unbleached kraft paper, basis weight: 50 g/m²) conveyed by a roller type winding machine (not shown) was coated with the hydrous composition 4 extruded through the outlet of the die 3. The laminate 6 obtained by coating was immediately pressed against the substrate 5 through a pressure roll (made of rubber) 7a, a cast roll (made of metal) 7b, and a touch roll (made of rubber) 7c, and then wound up into a roll form with a winding machine (not shown). Details of the single screw extruder used and its operation conditions and the temperature profile (Table 2) are shown below. The laminate obtained was placed in a hot air dryer at 90° C. and dried until the water content reached 12% by mass. In this way, a laminate composed of the gas barrier layer (I) and the substrate (II) adjacent to the gas barrier layer (I) was obtained. The gas barrier layer had a thickness of 20 μm.
Single screw extruder: extruder manufactured by Research Laboratory of Plastics Technology Co., Ltd. (40 mm in diameter, L/D=25)
Preset Temperature:

TABLE 2

| Single screw extruder cylinder | | | | | |
|---|---|---|---|---|---|
| C1 | C2 | C3 | C4 | Adapter | Die |
| 100° C. | 100° C. | 100° C. | 100° C. | 100° C. | 100° C. |

Discharge amount: 20 kg/hr
Die: 450 mm wide coat hanger die, lip opening=0.2 mm
Distance between die and cast roll (air gap): 150 mm

### Example 2

A laminate was obtained in the same manner as in Example 1, except that 79 parts by mass of the modified starch (A-1), 20 parts by mass of the water-soluble polymer (B-1), and 1 part by mass of the water-soluble polymer (B-2) were used as the raw materials of the resin composition.

### Examples 3 to 18 and Comparative Examples 1 to 4 and 8

A laminate was obtained in the same manner as in Example 1, except that the contents of the modified starch (A) and the water-soluble polymer (B), the kinds and contents of other substances, the thickness of the gas barrier layer (I), and the kind and basis weight of the substrate (II) were adjusted as shown in Table 3.

In Example 5, 54 parts by mass of modified starch (A-1) and 36 parts by mass of modified starch (A-2) were used as the modified starch (A), and in Comparative Examples 2 and 4, modified starch (A-2) was used as the modified starch (A). In the other Examples and Comparative Examples, modified starch (A-1) was used as the modified starch (A).

As the water-soluble polymer (B), water-soluble polymer (B-1) was used.

### Example 19

The hydrous composition obtained in Example 1 was formed into a film by a single screw extruder, affording a roll-shaped sheet (gas barrier layer (I)) having a thickness of 120 μm. The resulting roll-shaped sheet was mounted in a winding machine and was extrusion-coated with a PBAT/PLA blend at a thickness of 50 g/m² on one surface while being conveyed by a winding machine. In this way, a laminate composed of the gas barrier layer (I) and the substrate (II) adjacent to the gas barrier layer (I) was obtained.

The coating equipment and the coating conditions are as follows.
Single screw extruder: extruder manufactured by Research Laboratory of Plastics Technology Co., Ltd. (40 mm in diameter, L/D=25)
Preset Temperature:

TABLE 3

| Single screw extruder cylinder | | | | | |
|---|---|---|---|---|---|
| C1 | C2 | C3 | C4 | Adapter | Die |
| 180° C. | 200° C. | 220° C. | 220° C. | 220° C. | 220° C. |

Discharge amount: 20 kg/hr
Die: 450 mm wide coat hanger die, lip opening=0.2 mm
Distance between die and cast roll (Air gap): 150 mm

### Comparative Example 5

A laminate was obtained by forming an adhesive layer on a PVDC film (other material (C) in Table 3) such that the thickness after drying was 3 Jim, and laminating unbleached kraft paper (basis weight: 50 g/m²) on the adhesive layer. The adhesive layer was formed by applying a two-component adhesive using a bar coater and drying the adhesive. The two-component adhesive is a two-component reactive polyurethane-based adhesive composed of “TAKELAC (registered trademark) A-520” manufactured by Mitsui Chemicals, Inc. and “TAKENATE (registered trademark) A-50” manufactured by Mitsui Chemicals, Inc.

### Comparative Examples 6 and 7

A laminate was obtained in the same manner as in Comparative Example 5, except that the other materials (C) and the thickness of the gas barrier layer were as shown in Table 3.

### Comparative Example 8

A laminate was obtained in the same manner as in Comparative Example 5, except that the sheet (gas barrier layer (I)) obtained in Example 19 was used instead of the other materials (C).

The biodegradability, the adhesive strength, the oxygen permeability, and the repulpability of the laminates obtained in Examples and Comparative Examples were measured. The results are shown in Table 4. Note that * in the column of the adhesive strength in Table 4 indicates that the material of the substrate was broken, and means that the sample had sufficient adhesive strength.

TABLE 4

| | Gas barrier layer (I) | | | | | | |
|---|---|---|---|---|---|---|---|
| | | | Content | | | | |
| | Content | | (parts by | | | | |
| | (parts by | Amylose | mass) of | Types of | | Substrate (II) | |
| | mass) of | content | water- | other | | | Basis |
| | modified | (% by | soluble | materials | Thickness | | weight |
| | starch (A) | mass) | polymer (B) | (C) | (μm) | Type | (g/m²) |
| Example 1 | 90 | 70 | 10 | — | 20 | Unbleached kraft paper | 50 |
| Example 2 | 79 | 70 | 21 | — | 20 | Unbleached kraft paper | 50 |
| Example 3 | 70 | 70 | 30 | — | 20 | Unbleached kraft paper | 50 |
| Example 4 | 98 | 70 | 2 | — | 20 | Unbleached kraft paper | 50 |
| Example 5 | 90 | 50 | 10 | — | 20 | Unbleached kraft paper | 50 |
| Example 6 | 90 | 70 | 10 | — | 5 | Unbleached kraft paper | 50 |
| Example 7 | 90 | 70 | 10 | — | 50 | Unbleached kraft paper | 50 |
| Example 8 | 90 | 70 | 10 | — | 120 | Unbleached kraft paper | 50 |
| Example 9 | 90 | 70 | 10 | — | 450 | Unbleached kraft paper | 50 |
| Example 10 | 90 | 70 | 10 | — | 20 | Bleached kraft paper | 50 |
| Example 11 | 90 | 70 | 10 | — | 20 | Single gloss kraft paper | 40 |
| Example 12 | 90 | 70 | 10 | — | 20 | Glassine paper | 31 |
| Example 13 | 90 | 70 | 10 | — | 20 | Tissue paper | 21 |
| Example 14 | 90 | 70 | 10 | — | 20 | Rayon paper | 14 |
| Example 15 | 90 | 70 | 10 | — | 20 | White paperboard | 233 |
| Example 16 | 90 | 70 | 10 | — | 20 | Woodfree paper | 110 |
| Example 17 | 90 | 70 | 10 | — | 20 | Coated paper | 55 |
| Example 18 | 90 | 70 | 10 | — | 20 | Cellophane | 20 |
| Example 19 | 90 | 70 | 10 | — | 20 | PBAT/PLA blend | 50 |
| Comparative Example 1 | 0 | — | 100 | — | 10 | Unbleached kraft paper | 50 |
| Comparative Example 2 | 100 | 20 | 0 | — | 20 | Unbleached kraft paper | 50 |
| Comparative Example 3 | 100 | 70 | 0 | — | 20 | Unbleached kraft paper | 50 |
| Comparative Example 4 | 90 | 20 | 10 | — | 20 | Unbleached kraft paper | 50 |
| Comparative Example 5 | — | — | — | PVDC | 43 | Unbleached kraft paper | 50 |
| Comparative Example 6 | — | — | — | EVOH | 12 | Unbleached kraft paper | 50 |
| Comparative Example 7 | — | — | — | Aluminum foil | 12 | Unbleached kraft paper | 50 |
| Comparative Example 8 | 90 | 70 | 10 | — | 20 | Unbleached kraft paper | 50 |

| | | Evaluation of laminate | | | |
|---|---|---|---|---|---|
| | Presence | | | Oxygen | |
| | of | Degree of | Adhesive | permeability | |
| | adhesive | biodegradation | strength | (cc/[m²-atm-24 hr]) | |
| | layer | (%) | (N/15 mm) | 23° C., 50% RH | Repulpability |
| Example 1 | — | 99 | >5* | 2 | A |
| Example 2 | — | 92 | >5* | 2 | A |
| Example 3 | — | 90 | >5* | 1 | A |
| Example 4 | — | 100 | >5* | 4 | A |
| Example 5 | — | 99 | >5* | 2 | A |
| Example 6 | — | 100 | >5* | 8 | A |
| Example 7 | — | 98 | >5* | 0.8 | A |
| Example 8 | — | 97 | >5* | 0.3 | A |
| Example 9 | — | 95 | >5* | 0.1 | A |
| Example 10 | — | 99 | >5* | 2 | A |
| Example 11 | — | 99 | >3* | 2 | A |
| Example 12 | — | 99 | >4* | 2 | A |
| Example 13 | — | 98 | >3* | 2 | A |
| Example 14 | — | 99 | >5* | 2 | A |
| Example 15 | — | 100 | >6* | 2 | A |
| Example 16 | — | 100 | >6* | 2 | A |
| Example 17 | — | 99 | >5* | 2 | A |
| Example 18 | — | 99 | >5* | 2 | — |
| Example 19 | — | 95 | 7 | 2 | — |
| Comparative Example 1 | — | 79 | >5* | 0.1 | B |
| Comparative Example 2 | — | 100 | >5* | 80 | A |
| Comparative Example 3 | — | 100 | >5* | 20 | A |
| Comparative Example 4 | — | 98 | >5* | 40 | A |
| Comparative Example 5 | Present | 48 | >5* | 86 | C |
| Comparative Example 6 | Present | 72 | >5* | 0.2 | C |
| Comparative Example 7 | Present | 70 | >5* | <0.1 | C |
| Comparative Example 8 | Present | 78 | >5* | 2 | C |

For the laminates obtained in Examples 1 to 19, the evaluation of the repulpability was A, and it was confirmed that the oxygen permeability was low and the adhesive strength was high. In contrast, for the laminates obtained in Comparative Examples 1 and 5 to 8, the evaluation of the repulpability was B or C, and it was confirmed that the laminates obtained in Comparative Examples 2 to 5 were higher in oxygen permeability than those of Examples.

Thus, it was found that the laminate of the present invention is superior in gas barrier property, adhesive strength, and repulpability.

### DESCRIPTION OF REFERENCE SIGNS

1: Hydrous composition (pellet-like)
2: Single screw extruder
3: Die
4: Hydrous composition
5: Substrate
6: Laminate
7a: Pressure roll
7b: Cast roll
7c: Touch roll
8: Twin screw extruder
9: Hopper
10: Liquid addition nozzle
11: Resin temperature meter
12: Resin pressure meter
13: Adapter
14: Die

1. A laminate comprising: a gas barrier layer (I) comprising a modified starch (A) having an average amylose content of 45% by mass or more and a water-soluble polymer (B); and a substrate (II) adjacent to the gas barrier layer (I),
wherein the laminate exhibits a degree of biodegradation of 80% or more in a biodegradability test in accordance with ISO 14855-1.

2. The laminate according to claim 1, wherein the water-soluble polymer (B) is polyvinyl alcohol and/or polyoxyalkylene.

3. The laminate according to claim 1, wherein the content of the modified starch (A) is 40 to 98 parts by mass and the content of the water-soluble polymer (B) is 2 to 60 parts by mass based on 100 parts by mass in total of the modified starch (A) and the water-soluble polymer (B).

4. The laminate according to claim 1, wherein the gas barrier layer (I) has a thickness of 1 to 600 μm.

5. The laminate according to claim 1, wherein the substrate (II) is paper.

6. A multilayer structure having a heat seal layer or a moisture-proof layer on at least one surface of the laminate according to claim 1.

7. A packaging material or a lid material comprising the laminate according to claim 1.
